(19) United States
(12) Patent Application Publication
(10) Pub. No.: US 2007/0262117 A1
(43) Pub. Date: Nov. 15, 2007

(54) Earth/ground attachment for welding and cutting equipment

(75) Inventor: Anthony N. Thurston, Victoria (AU)

Correspondence Address: HARNESS, DICKEY & PIERCE, P.L.C., P.O. BOX 828, BLOOMFIELD HILLS, MI, 48303, US

(73) Assignee: Tanjant Tool Co. Pty.Ltd., Victoria (AU)

(21) Appl. No.: 11/431,407

(22) Filed: May 10, 2006

(51) Int. Cl. A47J 36/02

(52) U.S. Cl. 228/101

(57) ABSTRACT

A contact assembly for mounting to a clamp to provide an earth/ground connection for arc equipment, the assembly comprising an outer metal housing providing a mounting body of generally cylindrical form, a solid metal contact block mounted within the body and extending through an open end of the body to provide a contact surface for establishing electrical contact with a workpiece, a cable connector extending into the interior of the contact body for electrically coupling an earth/ground cable to the contact body, and means for attaching the housing to the clamp such that the contact body is electrically insulated from the clamp.

### CROSS-REFERENCE TO RELATED APPLICATIONS

1. Field

The present disclosure relates to earth/ground attachments for welding and cutting equipment operating on the basis of an electrical arc, and more particularly to contact assemblies for use in such attachments.

2. Background

The statements in this section merely provide background information related to the present disclosure and may not constitute prior art.

Welding involving the use of an electrical arc, such as manual arc welding (MAW), tungsten inert gas (TIG), and metal inert gas (MIG) welding processes, and plasma cutting processes involve the transfer of the working current in a full circuit from the power source of the equipment, to the workpiece and back to the power source via an earth/ground cable. Hereinafter such equipment will be collectively referred to as “arc equipment”, which term will include within its scope any other welding or cutting equipment which operates by electrical arc.

The quality of the weld or cut depends significantly on having an effective earth. Poor earthing can result in various problems including irregular weld metal transfer, sputtering, and arc failure. All arc equipment of the type discussed uses an earth/ground attachment for coupling the earth/ground cable to the workpiece and a poor earthing connection to the workpiece can cause the attachment device to heat or spark and in some cases cable burnout can occur as a result of heating resulting from electrical resistance within the attachment system.

Earth/ground attachment devices may need to handle very high currents, typically in the range of 600 to 700 amperes, and a poor earthing connection can cause irreparable damage to the attachment device itself. Prior forms of attachment devices are principally in the form of spring tongs (in effect, a spring clamp), screw clamps or magnetic. With clamps of tong-type and screw-type a poor earthing contact can result in the establishment of a secondary circuit to the workpiece back through the device itself resulting in heating and/or arcing effects within the device and this can easily lead to permanent damage. In the case of a screw clamp, arcing within the screw part of the device can even result in the screw part becoming welded in place, thereby making subsequent removal of the device extremely difficult. Likewise, magnetic-type devices can have significant problems in presenting a good contact with the workpiece due to accumulation of particles of metallic debris and the like and with these devices poor earthing contact with the working surface can result in significant heating of the device and in some instances the device can become welded to the work surface.

### SUMMARY

According to the present invention there is provided an earth/ground contact assembly for arc equipment for clamping against a workpiece, the assembly having a mounting part adapted to be mounted within an aperture within part of a clamp by which clamping pressure is applied, a contact body providing a contact surface for establishing electrical contact with the workpiece, means for coupling an earth/ground cable to the contact body, and means for electrically insulating the contact body from said part of the clamp.

Further according to the invention there is provided a contact assembly for mounting to a clamp to provide an earth/ground connection for arc equipment, the assembly comprising an outer metal housing providing a mounting body of generally cylindrical form, a solid metal contact block mounted within the body and extending through an open end of the body to provide a contact surface for establishing electrical contact with a workpiece, a cable connector extending into the interior of the contact body for electrically coupling an earth/ground cable to the contact body, and means for attaching the housing to the clamp such that the contact body is electrically insulated from the clamp.

Still further according to the invention there is provided an earth/ground clamp for arc equipment, said clamp having opposed arms, a contact assembly mounted to one of the arms by engagement within an aperture in that arm, the contact assembly including a contact body providing a contact surface for establishing electrical contact with a workpiece by actuation of the clamp, an electrically insulating mounting between the contact body and the arm of the clamp for electrically insulating the contact body from that arm of the clamp, and means associated with the contact body for coupling an earth/ground cable to the contact body.

Still further according to the invention there is provided a clamp according to claim 21, wherein the contact assembly includes an outer metal housing having a part within which the contact body is mounted so that the body extends through an open end of the housing to provide the contact surface, and the housing includes a screw-threaded mounting portion extending through the aperture in the arm of the clamp, the screw-threaded mounting portion being electrically insulated from the contact body and from the part of the housing within which the contact body is mounted,

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of an embodiment of an earth/ground attachment in accordance with one embodiment of the invention;

FIG. 2 is a section through the attachment of FIG. 1 to show details of the contact assembly of the attachment;

FIG. 2A is an enlarged view similar to FIG. 2 and showing the contact assembly in greater detail;

FIG. 3 is an exploded view showing the components of an alternative form of contact assembly;

FIG. 4 is a side view of an alternative embodiment of a contact assembly in accordance with the invention;

FIG. 5 is an axial cross-section of the assembly shown in FIG. 4;

FIG. 6 is a fragmentary radial cross-section through the main body part of the contact assembly;

FIG. 7 is an exploded view, partially in section, of the contact assembly of FIGS. 4 and 5;

FIG. 8 shows the contact assembly mounted to the arm of a screw clamp;

FIG. 9 shows the contact assembly mounted to the arm of a spring clamp;

FIG. 10 is a view similar to FIG. 4 of a modified version of the contact assembly;

FIG. 11 is an axial section through the contact assembly of FIG. 10; and

FIG. 12 is an exploded view, partially in cross-section, of the contact assembly of FIGS. 10 and 11.

### DETAILED DESCRIPTION

The following description is merely exemplary in nature and is not intended to limit the present disclosure, application, or uses.

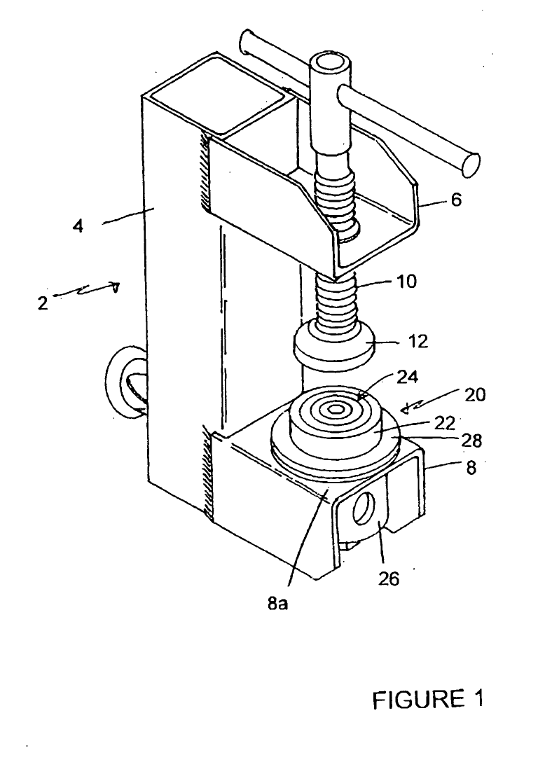

The attachment shown in FIGS. 1 to 3 is in the form of a screw clamp to which is mounted an insulated and replaceable contact assembly. The attachment comprises a rigid metal support frame 2 consisting of an upright 4 and opposed brackets 6,8 projecting from opposite ends of the upright 4. In the form shown, the upright 4 is of tubular section and the two brackets 6,8 are of channel section welded thereto, although it is to be understood that other structures which have the appropriate strength requirements could alternatively be adopted.

The bracket 6 carries a threaded clamping spindle 10 having a clamping pad 12 at its inner end and in the form shown the clamping spindle 10 is threadedly mounted within a threaded bushing 14 which is attached to the bracket 6. The threaded busing 14 provides a relatively long and robust threaded mounting for the spindle 10 and is thus capable of withstanding relatively high clamping pressures which are likely to arise in use. The clamping pad 12 is mounted at the inner end of the spindle 10 with a swivel action. Preferably, the pad 12 is removably attached to the spindle 10 by means of a screw 16 in order to permit removal and replacement of the spindle 10 in the event that the spindle 10 is struck by an arc during use with the thread becoming damaged.

The other bracket 8 carries a replaceable contact assembly 20 which is electrically insulated from the bracket 8 and therefore from the remainder of the frame 2 as will be subsequently described. The contact assembly 20 comprises a contact body 22 in the form of a solid block of a highly conductive relatively robust metal such as copper or brass, with copper being particularly preferred due to its superior conductivity. The contact block 22 has at its operative end a contact face 24 in alignment with the clamping pad 12 on the clamping spindle 10. Advantageously the clamping face 24 is profiled with a series of concentric ribs and grooves to facilitate displacement of small particulate matter on the work surface upon manipulation of the attachment to thereby reduce the likelihood of poor surface contact arising from surface contamination. The contact block 22 is mounted within an outer housing 26 of a somewhat stronger metal such as steel for reasons which will be explained. As shown the metal housing 26 is in the form of a sleeve having at its forward end a flange 28 (or, alternatively, another form of lateral projection), with the operative end portion of the contact block including the contact face 24 projecting beyond the flange 28. The contact block 22 is securely held within the housing 26. In the form shown, the contact block 22 is secured within the housing 26 by an internal circlip or snap ring, although alternatives could include a light pressfit or a retention screw. A cable connector sleeve 30 preferably also of copper extends through the wall of the housing 26 into a passage formed through the contact block 22 at the end thereof remote from the operative end and, as shown, that passage extends transversely to the axis of the contact block 22. The rear end of the housing 26 is formed with a threaded opening which receives a round nosed clamping screw 32 which is tightened against the connector sleeve 30 in order to compress that sleeve into intimate contact with the return cable leading to the equipment. The use of the housing 26 sleeve formed of a strong metal such as steel means that the thread for the clamping screw 32 is able to withstand the high loading needed to produce the requisite clamping pressure without risk of failure.

Cable stress can be a major cause of cable failure and in the attachment shown the cable is supported adjacent the contact assembly by passage through a flared tube 34 passing through the upright 4 of the frame 2, the cable being secured to the tube 34 by means of a hose clamp (not shown) although other restraints such as a cable tie could alternatively be used. The tube 34 is formed from steel which may be welded to the upright 4 or secured to the upright in any other suitable way. Alternatively the tube could be of an electrically insulating material, possibly of moulded construction, secured to the upright by snap fitting provided by a stepped diameter in the moulding or by a snap ring or snap clip or in any other suitable way.

As previously described, the bracket 8 within which the contact assembly 20 is mounted is of channel section in order to provide the necessary strength to withstand the clamping pressures which arise in use, the contact assembly 20 being mounted within a circular opening in the base wall 8a of the channel.

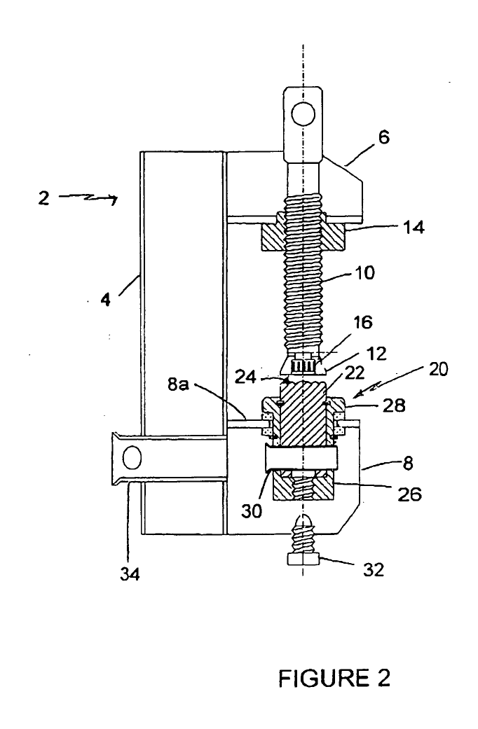

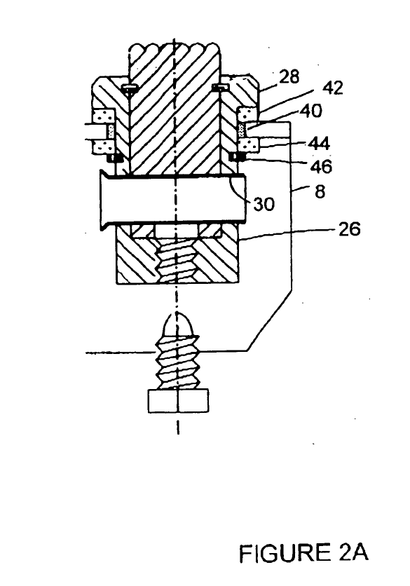

The contact assembly 20 is mounted to the bracket 8 by an insulating mounting which, in the form shown, consists of a series of three insulated washers 40, 42, 44 (see FIG. 2A). A first washer 40 is mounted within the circular opening in the wall 8a and acts as an insulating spacer ring to locate the housing 26 so that its outer peripheral surface is electrically isolated from the bracket 8. A second insulating washer 42 (the outer washer) is mounted on the housing 26 between the flange 28 and the outer (as shown, top) surface of the wall 8a in order to electrically isolate the flange 28 from the bracket 8 when the attachment is under clamping pressure. A third insulating washer 44 (the inner washer) is mounted on the housing to lie against the inner surface (as shown, the undersurface) of the wall 8a. A circlip 46 applied to the housing 26 adjacent the third insulating washer 44 ensures a firm, but releasable, mounting of the contact assembly to the bracket 8 and, of course, the third insulating washer 44 ensures that the circlip 46 is electrically isolated from the bracket 8.

In use, the contact assembly 20 will be subject to substantial heating under the high currents and it is necessary that the insulated mounting is able to withstand that heating, have high electrical insulation properties, and withstand the application of pressure for sustained periods under the clamping forces which arise. Suitable materials for the washers include ceramics and resin based composites. Of the three washers, it is the outer washer 42 between the flange 28 of the housing 26 and the wall 8a which carries the clamping pressure and by way of non-limiting example we have found that a compressed fibre composite identical to that commonly used in the manufacture of tap washers is particularly suitable. That composite is relatively inexpensive and is provided in sheet form so that the washers can easily be stamped out of the sheet. The inner washer 44 of identical size to washer 42 conveniently is also fabricated from the same material as could be the spacer ring 40 although if the spacer ring needs to be of a relatively small radial wall thickness it may be preferable to cut the ring from an epoxy resin composite tube or to form the ring by a resin casting.

Although in the form shown, the insulating mounting is formed by the three washers, in an alternative, a single moulded component could form the functions of the inner washer and spacer ring or outer washer and spacer ring; alternatively, two identical moulded components could be used each forming the function of either the inner or outer washer and a part of the spacer ring.

Although in the form shown the flange which applies the clamping pressure against the wall 8a via the outer washer is formed on the housing 26, alternatively it could be formed on the contact block itself with the housing being mounted just at the remote end portion of the contact block in order to carry the cable clamping screw 32.

In principle it would be possible to omit the housing 26, with the cable clamping screw 32 then being threaded into the contact block itself. While this would simplify the manufacture of the contact assembly, it is not the presently preferred construction although it is to be understood that this would fall within the broad scope of the present invention.

In the attachment particularly described, the contact assembly 20 and the cable are insulated from the remainder of the attachment so that the return current will flow from the workpiece into the contact block and then into the return cable via the compression sleeve 30 and it is thereby impossible for the current to flow through the spindle 10 and form a secondary return circuit which is the major cause of overheating with most existing ground clamps due to poor conductivity of the spindle. If there is poor contact due to failure to present clean metal to the contact face 24 of the contact block 22 this will become immediately evident to the operator. The contact face 24 of the contact block 22 can be sized to provide a relatively large contact area and the annular grooves/ribs on that face allow high contact pressure to be applied while excluding the ingress of weld spatter and other extraneous metallic matter which sometimes tends to flow onto the contact faces of existing ground clamps; the high contact pressure also overcomes minor unevenness in the work surface. The direct connection of the return cable to the copper contact block (of which the copper compression sleeve 30 can be considered to form a part) ensures that the current is delivered efficiently with no loss, thereby contributing to lower power consumption and less heating.

It is known that operators habitually increase the machine amperage in order to overcome resistance in the ground clamp and this causes greater heating and shortens clamp and cable life. This practice can be accommodated in the attachment described herein as the component principally prone to deterioration will be the contact assembly consisting of the contact block within its housing 26 and this can readily be replaced when required by removing the circlip 46 and inserting a new assembly which would typically be supplied together with a replacement insulating mounting consisting of a set of the three washers and also a circlip. The used contact assembly, apart from the washers, is fully recyclable.

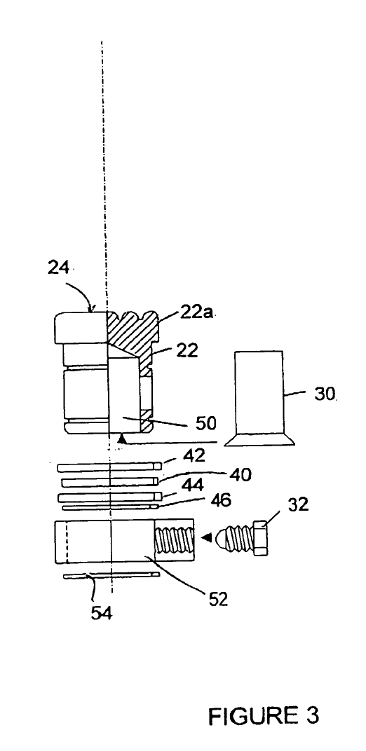

In the embodiment just described, the cable feeds into the contact block 22 transversely to the clamping axis. In the modified embodiment shown in FIG. 3, the cable feeds into the contact block 22 in the direction of the clamping axis. In this embodiment, the contact block 22 itself is shaped to form a flange 22a by which the clamping pressure is applied to the wall 8a of the bracket via the outer washer 42 and the copper cable compression sleeve 30 is mounted within an axial passage 50 in the contact block 22 opening onto the end of the block remote from the contact face 24. A steel housing ring 52 is mounted on that end portion of the contact block between the circlip 46 by which the contact assembly is mounted within the bracket and an outer ciclip 54. The wall of the housing ring 52 is formed with a threaded opening to receive the compression screw 32 which passes through an aperture in the peripheral wall of the contact block 22 into engagement with the compression sleeve 30. The incoming cable is supported by an appropriate insulated support attached to the frame.

Although the contact assembly 20 has been described as installed within a screw clamp, it is also applicable to other forms of clamp including tong-type spring clamps. In that case the replaceable contact assembly and insulated mounting as previously described is incorporated within a circular opening formed for that purpose in the end portion of one of the two arms of the spring tongs.

In the embodiments thus far described, the main body of the contact assembly fits within an aperture in an arm of the clamp and requires the clamp to be designed specifically to accept the contact assembly. In the embodiments now to be described, the body of the contact assembly includes an insulated screw-threaded mounting of reduced diameter relative to the remainder of the body to fit into a correspondingly sized opening, usually a mating internally threaded opening, within an arm of the clamp which permits the use of the contact assembly in clamps of more conventional design.

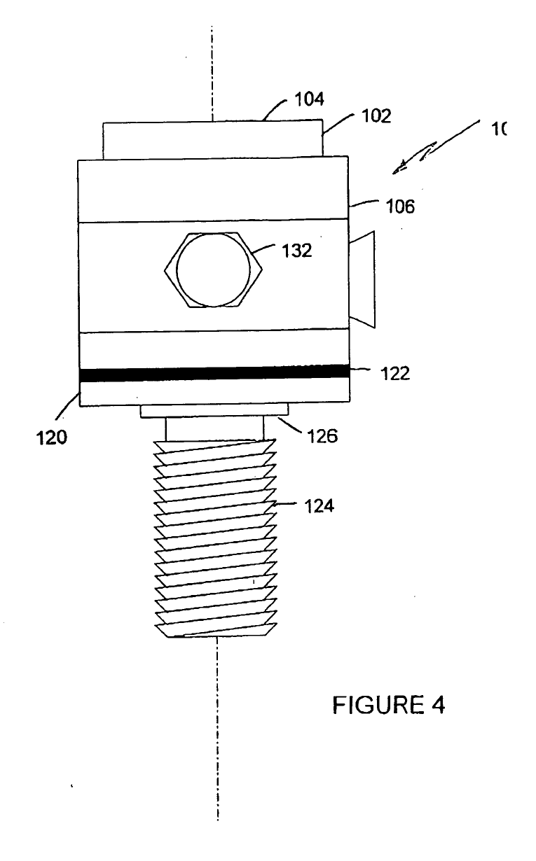

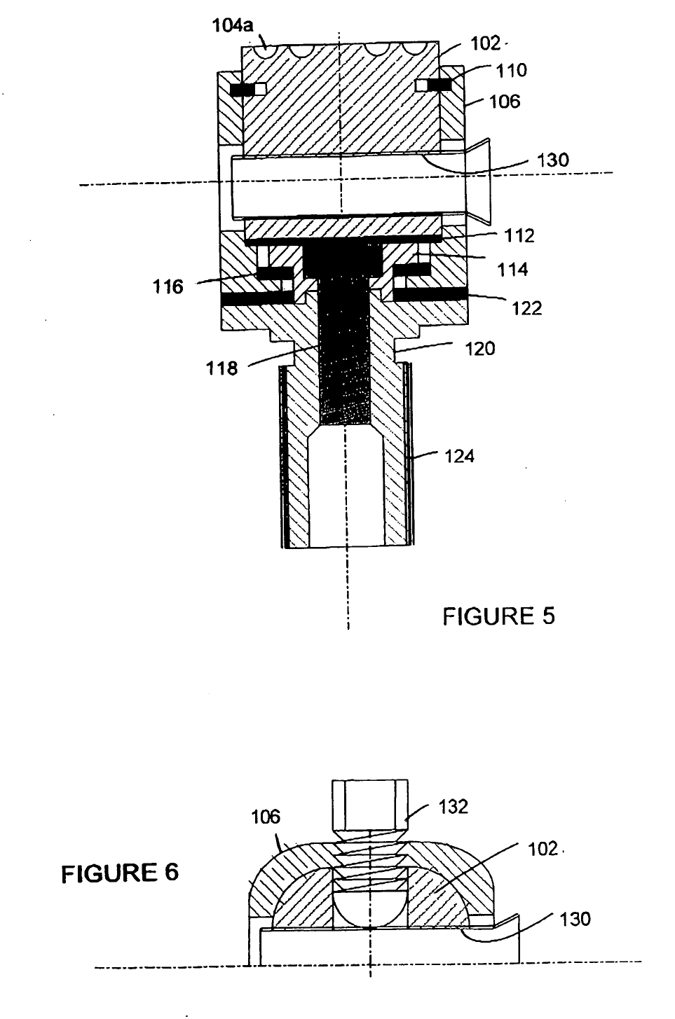

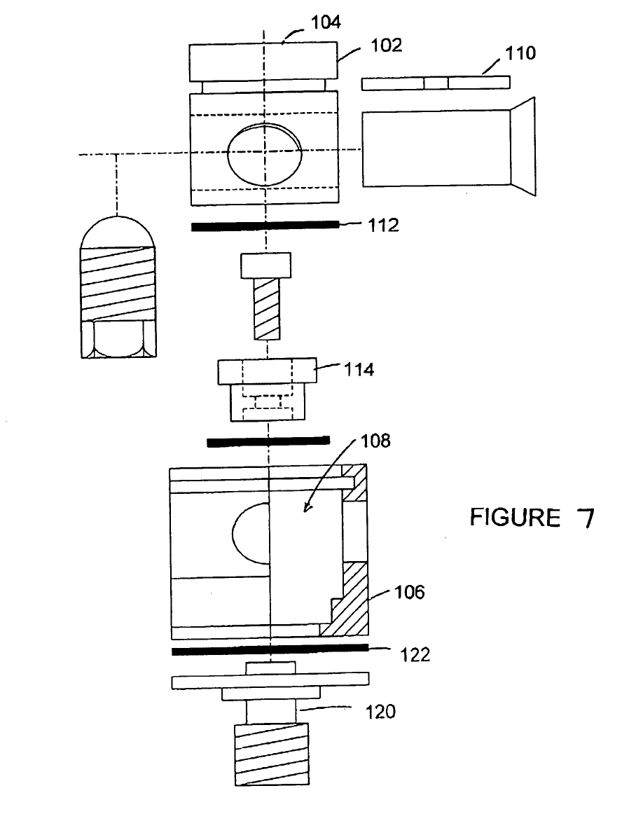

As shown in FIGS. 4 to 7, the contact assembly 100 of this embodiment comprises a contact body 102 in the form of a solid block of a highly conductive relatively robust metal such as copper or brass, with copper being particularly preferred due to its superior conductivity. The contact block has at its operative end a contact face 104. Advantageously the contact face 104 is profiled with a series of concentric ribs and grooves 104a (see FIG. 5) to enable high contact pressure and facilitate displacement of small particulate matter on the work surface and thereby reduce the likelihood of poor surface contact arising from surface contamination, as discussed in relation to the previous embodiment. The contact block 102 is mounted within a generally cylindrical main body part 106 of an outer housing, the body part 106 being of a somewhat stronger metal such as steel. The bore 108 within the interior of the body part 106 is formed with a cylindrical stepped diameter at its lower end portion, with reference to the orientation of FIG. 4.

As shown, the contact block 102 is fitted into the main part of the bore of the body part 106 and is retained therein by a circlip 110 although other retention means could alternatively be used. The lower end of the contact block 102 bears against a first step within the bore via a disc 112 of electrically insulating material. A stepped boss 114 is mounted beneath the insulating disc 112 and bears against a second step of the bore 108 via a washer 116 of electrically insulating material. A screw 118 is mounted within an axial passage extending through the boss 114 to attach a threaded mounting portion 120 to the underside of the body part 106 via a washer 122 of electrically insulating material. The outer housing can thus be considered to be formed by the body part 106 and the mounting portion 120 attached thereto.

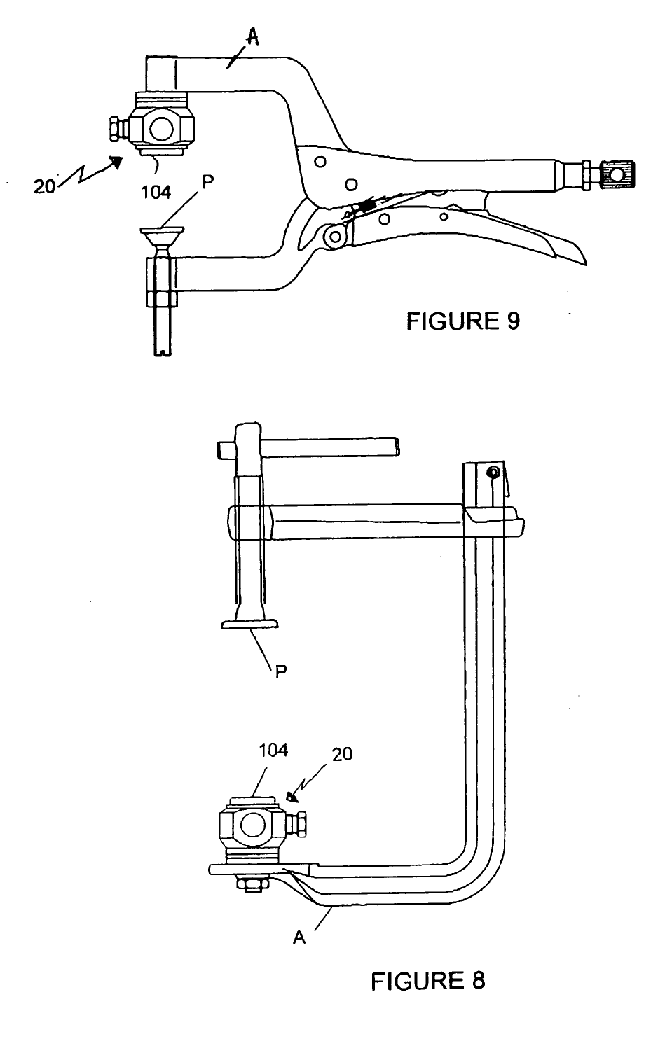

It will be seen from FIG. 5 that the stepped diameters of the boss 114 are less than those of the corresponding parts of the bore 108 within the body part 106, and the washers 116 and 122 act to locate the boss 114 radially relative to the axis of the body part 106 to ensure that the boss 114 is always maintained out of electrical contact from the body part 106 by a sufficient distance even to prevent arcing under the high currents to which the contact assembly will be subjected in use. The mounting portion 120 which is attached to the main body part 106 of the housing by the screw 118 is externally threaded at 124 to fit into a corresponding opening formed in an arm of a clamp-type attachment so that the contact face 104 of the contact block 102 will lie in opposed relation to a clamping pad on an opposing arm of the attachment. FIG. 8 shows the contact assembly 20 applied to the arm A of a screw clamp so that the contact face 104 lies opposite to clamping pad P, and FIG. 9 shows the contact assembly 20 when applied to the arm A of spring tongs (a spring clamp, in effect) to face clamping pad P. The threaded mounting 124 which is of reduced diameter in relation to that of the main body part 106 can either be threadedly received within the opening in the clamp arm if the opening is itself internally threaded, or alternatively the mounting 124 can carry a nut tightened into engagement with the underside of the clamp arm. In its secured position, the mounting portion 120 will be applied firmly against the clamp arm by engagement of a flange 126 against the upper surface of the arm.

It will be understood that with the arrangement of the insulating disc 112 and washers 116,122 as show not only are the boss 114 and screw 118 electrically insulated from the main body part 106, the threaded mounting portion 120 is also electrically insulated from the main body part 106 by the insulating washer 122.

The insulating disc and washers 112, 116, 122 will be subject to sustained compressive loading under the clamping forces which arise during operation and by way of example it is preferred to form these from compressed fibre composite identical to that commonly used in the manufacture of tap washers as discussed in relation to the previous embodiment. It is however to be understood that other materials could be used, for example ceramics or other composites.

Although the threaded mounting portion 120 will itself be firmly anchored to the arm of the clamp, the main body part 106 together with the contact block 102 is able to rotate relative to the mounting 120 about its axis as the fitting arrangement although serving to fix the body part 106 axially, does not restrain it against rotational movement relative to the boss 114 and the components attached thereto. This ability to permit rotational movement of the main body part 106 is of significance in facilitating ease of location of the return cable as will now be described.

The contact block 102 includes a copper compression sleeve 130 extending diametrically through the block 102 and also through enlarged aligned apertures in the main body part 106 to terminate at one end in a flared opening to facilitate insertion of the cable. A sleeve compression screw 132 with a domed tip extends through aligned radial openings in the housing 106 and contact block 102 to engage a side of the compression sleeve 130 so that the screw 132, when tightened, deforms the sleeve 130 into intimate engagement with the end portion of the cable inserted into the sleeve. It will be noted that the compression screw 132 being orientated radially will not exert any axial loading on the contact block 102 and will therefore not interfere with the attachment of the block 102 within the body part 106 by means of the circlip 110.

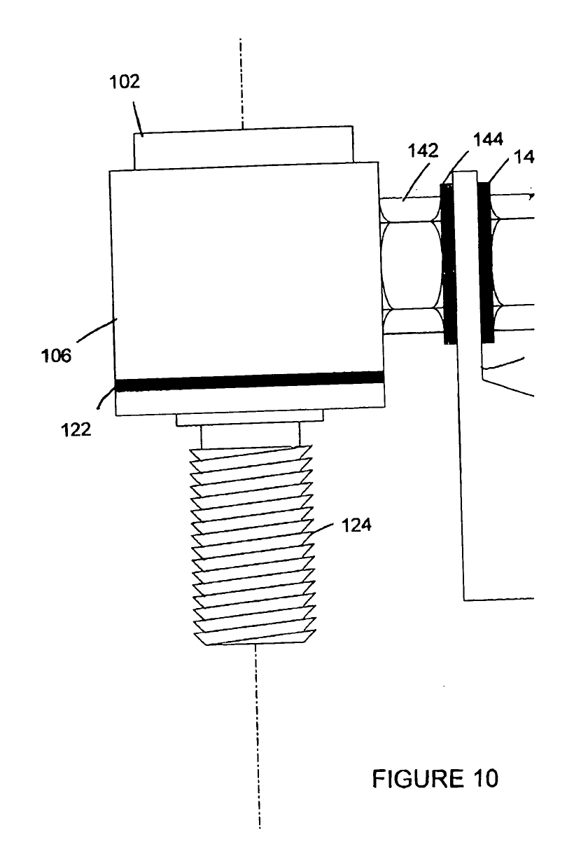

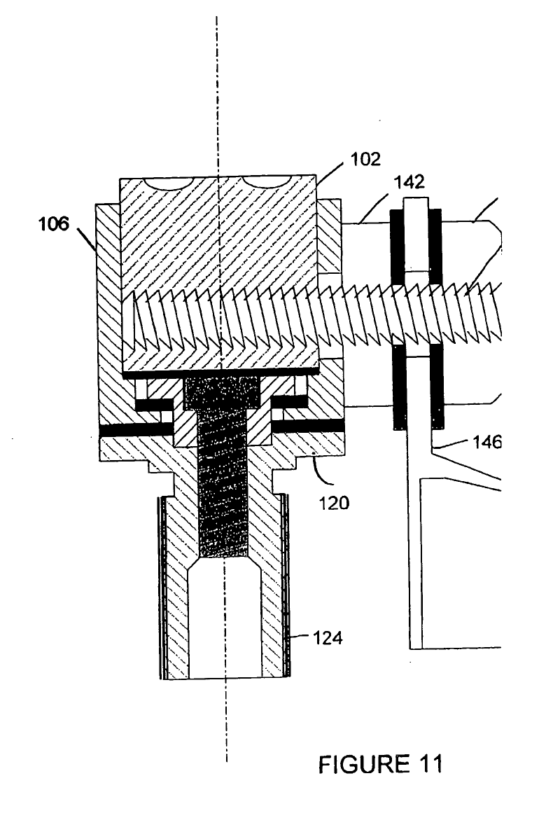

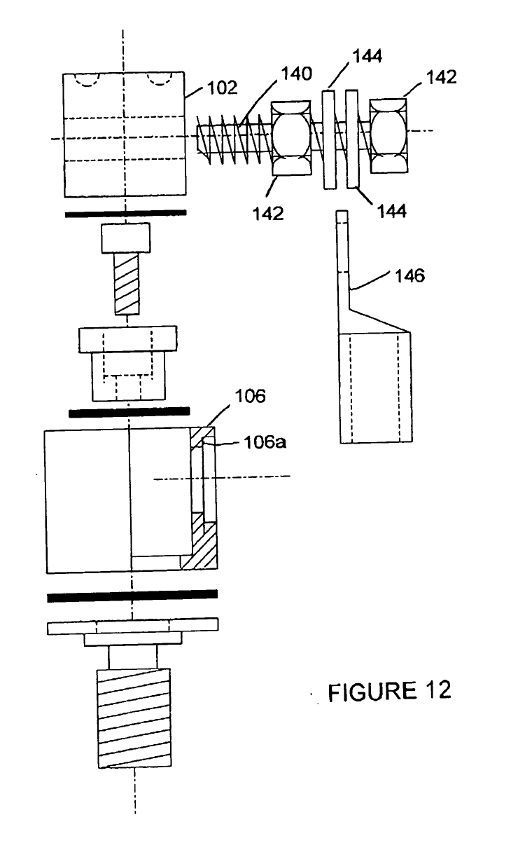

In an alternative version shown in FIGS. 10 to 12, instead of providing a compression sleeve to anchor the cable to the block 102, the block 102 is internally threaded to receive a threaded rod 140, for example of brass, which projects externally through a radial aperture in the wall of the main body part 106. The screw 140 carries nuts 142 and washers 144, also of brass whereby a so-called cable field lug 140 attached to the end of the return cable can be firmly clamped between the washers 144. The outer surface of the maim body part 106 is provided with a flat seat 106a (see FIG. 12) to receive the inner edge of the inner nut 142 so that the nut 142 can be held in tight clamping engagement with the main body part 106. It will be understood that with this configuration, the contact block 102 will thereby be retained tightly within the main body part 106 by the threaded rod 140 and inner nut 142 so discrete fixing means such as the circlip as used in the previous version, is no longer required. This version is particularly suitable for lower amperage applications. This means for cable attachment can also be used in the embodiment of FIGS. 1 to 3.

In both versions just described, although the cable is required to be anchored to the contact assembly at a fixed position relative to the main body, nevertheless the ability for the main body to rotate axially relative to its threaded mounting portion 120 means that the orientation of the cable can be changed to best suit the particular use and for example may be clamped or tied to the attachment itself in a suitable position.

The embodiments described with reference to FIGS. 4 to 12 thus provide a contact assembly in which a housing within which is mounted the contact block includes a mounting portion by which the contact assembly can be releasably mounted to an arm of a clamp, specifically as described by engagement in a threaded or other seat in the clamp. Although as described the mounting portion is attached to the main body part of the housing by cooperation between the boss, the screw and the mounting portion via the interposition of the electrically insulating disc/washers, it is to be understood that the configuration of these insulating components could be different to that specifically shown. Moreover it would be possible to fabricate certain of the components from electrically insulating materials; for example the boss and/or the threaded mounting could be fabricated from an insulating material such as a resin-based material or a ceramic to provide the required electrical insulation between the clamp arm and the contact block.

The embodiments have been described by way of example and modifications are possible within the scope of the invention.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers.

The reference to any prior art in this specification is not, and should not be taken as, an acknowledgment or any form of suggestion that prior art forms part of the common general knowledge in Australia.

What is claimed is:

1. An earth ground contact assembly for arc equipment for clamping against a workpiece, the assembly having a mounting part adapted to be mounted within an aperture within part of a clamp by which clamping pressure is applied, a contact body providing a contact surface for establishing electrical contact with the workpiece, means for coupling an earth/ground cable to the contact body, and means for electrically insulating the contact body from said part of the clamp.

2. A contact assembly according to claim 1, wherein the contact body is mounted within a hollow body part of a housing and projects from an open end of the body part, and part of the housing is adapted to lie within the aperture in the clamp.

3. A contact assembly according to claim 2, wherein the means for electrically insulating the contact body from the said part of the clamp comprise electrically insulating spacers for mounting the housing from the said part of the clamp to prevent electrical contact between the housing and the clamp in the zone of the aperture.

4. A contact assembly according to claim 3, wherein the housing includes a flange adapted to lie adjacent to a face of the clamp around the aperture and the insulating spacers comprise a washer adapted to lie between the flange and the face of the clamp and a spacer of insulating material seated within the aperture to locate the housing.

5. A contact assembly according to claim 2, wherein the housing includes a screw-threaded mounting portion at an end of the body part remote from the open end, the threaded mounting portion being engageable through the aperture in the clamp, and the screw-threaded mounting portion being electrically insulated from the contact body to the said part of the clamp.

6. A contact assembly according to claim 5, wherein the body part of the housing and the threaded mounting portion of the housing are separate components coupled together so that the body part and contact body mounted therein are able to rotate relative to the threaded mounting portion about the axis of the threaded mounting portion.

7. A contact assembly according to claim 6, wherein the body part and the threaded mounting portion are composed of metal and the threaded mounting portion is physically separated from the body part by electrically insulating spacers.

8. A contact assembly according to the claim 7, wherein the threaded mounting portion is connected to the body part of the housing by a screw located on the axis of the threaded mounting part and carried by a boss mounted within the interior of the body part and electrically insulated therefrom,

9. A contact assembly according to claim 2, wherein the contact body is in the form of a solid metal block, and the means for coupling the cable comprises a cable compression sleeve within a passage extending through the block, the cable compression sleeve serving to receive the end portion of the cable, and a compression screw carried by the housing for compressing the sleeve into intimate engagement with the end portion of the cable.

10. A contact assembly according to claim 2, wherein the contact body is in the form of a solid metal block, and the means for coupling the cable comprises a threaded rod engaged with a threaded passage in the block and extending externally of the housing to receive nuts and washers for co-operation with a connecting lug at the end of the cable.

11. A contact assembly according to claim 10, wherein a nut applied to the rod is tightened against the housing to anchor the contact block within the housing.

12. A contact assembly according to claim 2, wherein the contact surface of the contact body is defined by a series of concentric annular ribs.

13. A contact assembly for mounting to a clamp to provide an earth/ground connection for arc equipment, the assembly comprising an outer metal housing providing a mounting body of generally cylindrical form, a solid metal contact block mounted within the body and extending through an open end of the body to provide a contact surface for establishing electrical contact with a workpiece, a cable connector extending into the interior of the contact body for electrically coupling, an earth/ground cable to the contact body, and means for attaching the housing to the clamp such that the contact body is electrically insulated from the clamp.

14. A contact assembly according to claim 13, wherein the means for coupling the cable comprises a cable compression sleeve within a passage extending through the block, the cable compression sleeve serving to receive the end portion of the cable, and a compression screw carried by the mounting body for compressing the sleeve into intimate engagement with the end portion of the cable.

15. A contact assembly according to claim 14, wherein the compression screw extends radially relative to the mounting body.

16. A contact assembly according to claim 13, wherein the means for coupling the cable comprises a threaded rod engaged with a threaded passage in the block and extending externally of the housing to receive nuts and washers for co-operation with a connecting lug at the end of the cable.

17. A contact assembly according to claim 13, wherein the attachment means comprises a screw-threaded portion of the housing electrically insulated relative to the contact body and engageable within an aperture in the clamp.

18. A contact assembly according to claim 17, wherein the mounting body of the housing is separate from the screw-threaded portion and is rotatable about its axis relative to the screw-threaded portion.

19. A contact assembly according to claim 18, wherein the screw-threaded portion is electrically insulated from the mounting body to provide the electrically insulation for the contact block relative to the clamp.

20. An earth/ground clamp for arc equipment having a contact assembly according to claim 13 mounted to an arm of the clamp so that the contact surface of the contact body provides a clamping face on that arm to lie opposite a clamping face on an opposing arm of the clamp.

21. An earth/ground clamp for arc equipment, said clamp having opposed arms, a contact assembly mounted to one of the arms by engagement within an aperture in that arm, the contact assembly including a contact body providing a contact surface for establishing electrical contact with a workpiece by actuation of the clamp, an electrically insulating mounting between the contact body and the arm of the clamp for electrically insulating the contact body from that arm of the clamp, and means associated with the contact body for coupling an earth/ground cable to the contact body.

22. A clamp according to claim 21, wherein the contact assembly includes an outer metal housing having a part within which the contact body is mounted so that the body extends through an open end of the housing to provide the contact surface, and the housing includes a screw-threaded mounting portion extending through the aperture in the arm of the clamp, the screw-threaded mounting portion being electrically insulated from the contact body and from the part of the housing within which the contact body is mounted.

23. A clamp according to claim 22, wherein the part of the housing within which the contact block is mounted is rotatable relative to the screw-threaded mounting portion.
